(19) United States
(12) Patent Application Publication
(10) Pub. No.: US 2020/0234833 A1
(43) Pub. Date: Jul. 23, 2020

(54) A sintered nuclear fuel pellet, a fuel rod, a fuel assembly, and a method of manufacturing a sintered nuclear fuel pellet

(71) Applicant: WESTINGHOUSE ELECTRIC SWEDEN AB, Västerås (SE)

(72) Inventors: Simon Middleburgh, Chester (GB); Lars Hallstadius, Västerås (SE); Mattias Puide, Västerås (SE)

(73) Assignee: WESTINGHOUSE ELECTRIC SWEDEN AB, Västerås (SE)

(21) Appl. No.: 16/486,330

(22) PCT Filed: Jan. 15, 2018
(86) PCT No.: PCT/EP2018/050833

§ 371 Date: Aug. 15, 2019

(30) Foreign Application Priority Data
Feb. 21, 2017 (EP) 17157113.6

(51) Int. Cl. G21C 3/07; G21C 3/04; G21C 3/62; G21C 21/02; G21C 3/32

(52) U.S. Cl. CPC G21C 3/07; G21C 3/045; G21C 3/32; G21C 21/02; G21C 3/623

(57) ABSTRACT

Disclosed are a sintered nuclear fuel pellet, a fuel rod, a fuel assembly and a method of manufacturing the nuclear fuel pellet. The pellet comprises a matrix of UO₂ and particles dispersed in the matrix. The particles comprises a uranium-containing material. Each of the particles is encapsulated by a metallic coating. The uranium-containing material has a uranium density that is higher than the uranium density of UO₂. The metallic coating consists of at least one metal chosen from the group of Mo, W, Cr, V and Nb.

### TECHNICAL FIELD OF THE INVENTION

The present invention refers generally to a sintered nuclear fuel pellet suitable for use in nuclear reactors, for instance water cooled reactors, including light water reactors such as Boiling Water reactors BWR and Pressurized Water reactors PWR. The sintered fuel pellet is also suitable for use in the next generation reactors, both fast reactors such as lead-fast reactors, and thermal reactors, such as small modular reactors.

Specifically, the present invention refers to a sintered nuclear fuel pellet including a matrix of UO₂ and particles dispersed in the matrix. The invention also refers to a fuel rod and a fuel assembly for use in a nuclear reactor. Furthermore, the invention refers to a method of manufacturing the sintered nuclear fuel pellet.

### BACKGROUND OF THE INVENTION AND PRIOR ART

The dominant nuclear fuel used today comprises sintered nuclear fuel pellets of uranium dioxide, UO₂. Uranium dioxide is an excellent nuclear fuel having a melting point of 2865° C. However, there is a demand for improvements in certain respects. An increase of the uranium density, would improve the economy of the fuel. An increase of the thermal conductivity, would improve the in reactor behavior of the pellet and thus make it more suitable for the next generation reactors, providing attributes that may be amenable to so called accident tolerant fuels, ATF.

One problem with some unconventional uranium-containing materials is that they have a higher reactivity with water than UO₂. This creates a need for additional protection of the uranium-containing material from penetration of water, especially in water cooled reactors.

JP-11202072 refers to nuclear fuels comprising uranium nitride. FIG. 1 of this prior art document discloses a particle of uranium nitride which is provided with a coating. The coating could be an oxide film such as aluminum oxide, zirconium oxide or silicon oxide, a carbon coating, such as graphite or film including carbon compounds such as SiC, or a metallic film. FIG. 5 of the prior art document discloses a nuclear fuel pellet comprising a matrix of UO₂ and coated UN particles dispersed in the matrix.

Another problem is the rather poor ability to sinter certain uranium-containing materials together with uranium dioxide. These uranium-containing material are not compatible with uranium dioxide in standard sintering furnace conditions, for instance H₂ with H₂O/CO₂.

### SUMMARY OF THE INVENTION

An object of the present invention is to provide an improved nuclear fuel pellet which has a high uranium density and a high thermal conductivity, in particular a higher uranium density and a higher thermal conductivity than conventional uranium dioxide. A further object is to overcome the problems indicated above related to the use of high density uranium-containing materials.

These objects are achieved by the sintered nuclear fuel pellet initially defined, which is characterized in that the metallic coating consists of at least one metal chosen from the group of Mo, W, Cr, V and Nb.

By means of these metallic coatings, penetration of aggressive species such as water and other oxidizers (from the sintering furnace or the oxide itself) to the particles may be efficiently prevented. No water can reach the particles and the encapsulated uranium-containing material, also in the case of a defect fuel cladding permitting water or steam to reach the fuel pellet. The metallic coating ensures that the encapsulated uranium-containing material is separated from any contact with the uranium dioxide of the matrix during normal operation of the reactor and in case of a defect fuel rod.

These metals, when applied as a coating on the particles, permit the particles and uranium dioxide powder to be compacted together to a green pellet together with, and the compacted green pellet to be sintered to a nuclear fuel pellet having a proper mechanical strength.

The metallic coating may be formed by a single one of the metals Mo, W, Cr, V and Nb, or an alloy of two or more of these metals, for instance Mo—Cr, Mo—W, Cr—W or Cr—Mo—W. These metals and alloys all have a high melting point.

According to an embodiment of the invention, the at least one metal is atomic layer deposited on the particle.

According to an embodiment of the invention, the at least one metal is electro-plated on the particle.

According to an embodiment of the invention, the at least one metal is deposited on the particle via a sol-gel technique followed by heat treatment.

According to an embodiment of the invention, the uranium-containing material comprises at least one of uranium silicide, uranium nitride and uranium boride. These uranium-containing materials may all have a higher uranium density than uranium dioxide, and may thus contribute to improve the fuel economy of the nuclear fuel pellet in comparison with a standard nuclear fuel pellet of uranium dioxide. These uranium-containing materials may also have a higher thermal conductivity than uranium dioxide, and may thus improve the thermal transport efficiency of the nuclear fuel pellet during operation of the reactor in comparison with a standard nuclear fuel pellet of uranium dioxide.

The problem of an increased reactivity with water of the uranium-containing materials in comparison to uranium dioxide is solved in an elegant manner by the metallic coating of particles by at least one of said metals Mo, W, Cr, V and Nb.

According to an embodiment of the invention, the uranium-containing material comprises or consists of at least one of U₃Si₂, USi, U₃Si, U₂₀Si₁₆N₃, UN, and UB₂. All these uranium-containing materials fulfill the above mentioned criteria of a high uranium density and a high thermal conductivity. They all permit a metallic coating of at least one of said metals to be applied to produce an encapsulated particle.

According to an embodiment of the invention, the uranium-containing material comprises at least one of UN and U₂₀Si₁₆N₃, wherein the nitrogen of the uranium-containing material is enriched to contain a higher percentage of the isotope ¹⁵N than natural N, for instance at least 60, 70, 80 or 90% by weight of the isotope ¹⁵N.

According to an embodiment of the invention, the particles also comprise a neutron absorber. Fuel pellets comprising particles with a neutron absorber may advantageously be used, for instance in some of the fuel rods in some of the fuel assemblies of a nuclear reactor, to control the reactivity of the reactor over time, for instance during a fuel cycle.

According to an embodiment of the invention, the neutron absorber comprises ZrB₂. ZrB₂ has an extremely high melting point of 3246° C., and thus could easily survive pellet operation temperatures. For instance, the particles may comprise a mixture of UN and ZrB₂, or a mixture of U₃Si₂ and ZrB₂.

According to an embodiment of the invention, the uranium-containing material comprises UBₓ, especially UB₂, wherein the boron of said UBₓ forms said neutron absorber.

According to an embodiment of the invention, the boron is enriched to contain a higher percentage of the isotope ¹⁰B than natural B, for instance at least 20, 30, 40, 50, 60, 70, 80 or 90% by weight of the isotope 10B.

According to an embodiment of the invention, the particles have a maximum extension that lies in the range from 100 microns to 2000 microns. The particles could have any shape, for instance a ball shape or spherical shape, wherein the maximum extension is the diameter of the particle.

The object is also achieved by the fuel rod initially defined, which comprises a cladding tube enclosing a plurality of the sintered nuclear fuel pellets.

The object is also achieved by the fuel assembly initially defined, which comprises a plurality of the fuel rods.

The object is also achieved by the manufacturing method initially defined, which comprises the steps of: providing a powder of an uranium-containing material, sintering the uranium-containing material to form a plurality of particles, applying a metallic coating on the particles to form a plurality of coated particles, providing a powder of uranium dioxide, mixing the powder of uranium dioxide and the coated particles to provide a mixture, compressing the mixture to form a green body, sintering the green body to the sintered nuclear fuel pellet.

The method will result in the sintered nuclear fuel pellet by which the object mentioned above is achieved.

According to an embodiment of the invention, the application step comprises applying the metallic coating on the particles by atomic layer deposition.

According to an embodiment of the invention, the application step comprises applying the metallic coating on the particles by electro-plating.

### BRIEF DESCRIPTION OF THE DRAWINGS

The invention is now to be explained more closely through a description of various embodiments and with reference to the drawings attached hereto.

FIG. 1 discloses schematically a longitudinal sectional view of a fuel assembly for a nuclear reactor.

FIG. 2 discloses schematically a longitudinal sectional view of a fuel rod of the fuel assembly in FIG. 1.

FIG. 3 discloses schematically a longitudinal sectional view of a nuclear fuel pellet according to a first embodiment.

FIG. 4 discloses schematically a sectional view of a particle contained in the pellet in FIG. 3.

FIG. 5 discloses schematically a longitudinal sectional view of a nuclear fuel pellet according to a second embodiment.

### DETAILED DESCRIPTION

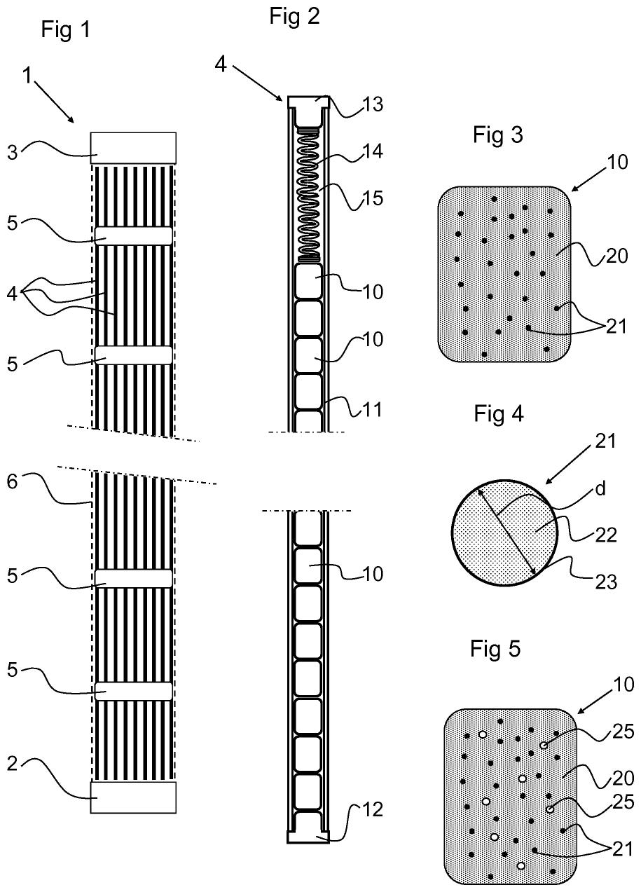

FIG. 1 discloses a fuel assembly 1 for use in nuclear reactor, in particular in a water cooled light water reactors, LWR, such as a Boiling Water Reactor, BWR, or a Pressurized Water reactor, PWR. The fuel assembly 1 comprises a bottom member 2, a top member 3 and a plurality of elongated fuel rods 4 extending between the bottom member 2 and the top member 3. The fuel rods 4 are maintained in their positions by means of a plurality of spacers 5. Furthermore, the fuel assembly 1 may, for instance when to be used in a BWR, comprise a flow channel or fuel box indicated by dashed lines 6 and surrounding the fuel rods 4.

FIG. 2 discloses one of the fuel rods 4 of the fuel assembly 1 of FIG. 1. The fuel rod 4 comprises a nuclear fuel in the form of a plurality of sintered nuclear fuel pellets 10, and a cladding tube 11 enclosing the nuclear fuel pellets 10. The fuel rod 4 comprises a bottom plug 12 sealing a lower end of the cladding tube 11, and a top plug 13 sealing an upper end of the fuel rod 4. The nuclear fuel pellets 10 are arranged in a pile in the cladding tube 11. The cladding tube 11 thus encloses the fuel pellets 10 and a gas. A spring 14 is arranged in an upper plenum 15 between the pile of nuclear fuel pellets 10 and the top plug 13. The spring 14 presses the pile of nuclear fuel pellets 10 against the bottom plug 12.

A first embodiment of one of the nuclear fuel pellets 10 is disclosed more closely in FIG. 3. The nuclear fuel pellet 10 comprises a matrix 20 of uranium dioxide, UO₂, and a plurality of particles 21, which are dispersed in the matrix 20, preferably uniformly and randomly.

The number of particles 21 in each nuclear fuel pellet 4 may be very high. The volume ratio particles/matrix may be from a low concentration of particles 21 of about 100 ppm up to the packing fraction.

In FIG. 4, the particle 21 has a spherical shape. However, the particle 21 may be a form of any shape.

The size of the particles 21 may vary. Preferably, the particles 21 may have an extension, for instance the diameter d in the spherical example of FIG. 4, which lies in the range from 100 microns to 2000 t microns.

The particles 21 comprise or consist of a uranium-containing material 22 having a uranium density that is higher than the uranium density of UO₂. In particular, the uranium-containing material 22 comprises or consists of at least one of uranium silicide, uranium nitride and uranium boride.

More specifically, the uranium-containing material 22 comprises or consists of at least one of U₃Si₂, USi, U₃Si, U₂₀Si₁₆N₃, UN and UB₂. The uranium density of each of these uranium-containing materials 22 is higher than 9.7 g/cm³, which is the uranium density of uranium dioxide. Also the thermal conductivity is higher, and generally increases with the temperature.

The uranium-containing material 22 of each particle 21 may thus comprise or consist of a single one of these substances, or a combination of two or more of these substances.

The uranium in the matrix 20 and in the uranium-containing materials 22 can be enriched to contain a higher percentage of the fissile isotope ²³⁵U than natural uranium.

Each of the particles 21 is encapsulated by a metallic coating 23 that completely surrounds and encloses the particle 21. The uranium-containing material 22 is thus completely separated from any contact with the uranium dioxide of the matrix 20.

The metallic coating 23 consists of at least one metal chosen from the group of Mo, W, Cr, V and Nb. These metals ensures of reliable protection of the uranium-containing material 22. They have all a high melting point and will thus survive pellet operation temperatures also in case of an accident, such as a LOCA, Loss Of Coolant Accident. The melting point of Mo is 2622° C., of Cr 1907° C., of W 3414° C., of V 1910° C., and of Nb 2477° C.

The metallic coating 23 may be formed by a single one of the metals Mo, W, Cr, V and Nb. The metallic coating 23 may also be formed by an alloy of two or more of these metals. Preferred alloys are Mo—Cr, Mo—W, Cr—W or Cr—Mo—W.

The thickness of the metallic coating 23 is preferably thin, for instance in the order of less than one micron.

The metallic coating 23 may as mentioned above cover the whole outer surface of the uranium-containing material 22.

The metallic coating 23 may be electro-plated, atomic layer deposited, or deposited by means of a sol-gel technique. The particles 21 may also comprise a neutron absorber. The neutron absorber may comprise or consists of ZrB₂. Each or some of the particles 21 may then comprise a mixture of at least one of the uranium-containing materials 20 and the neutron absorber, for instance UN/ZrB₂, U₃Si₂/ZrB₂, USi/ZrB₂, U₂₀Si₁₆N₃/ZrB₂ and U₃Si/ZrB₂.

The uranium-containing material 22 of the particles 21 may also comprise UBₓ, especially UB₂ as mentioned above, wherein the boron of UBₓ forms the neutron absorber. Other uranium boride compounds are possible, for instance UB₄, UB₁₂, etc. The uranium boride may then be mixed with at least one of the above-mentioned compounds U₃Si₂, USi, U₃Si, U₂₀Si₁₆N₃ and UN in any suitable proportion to ensure that the uranium density of the uranium-containing material is higher than for uranium dioxide.

FIG. 5 discloses a second embodiment according to which the sintered nuclear fuel pellet 10 comprises uranium-containing particles 21 and absorbing particles 25, wherein the absorbing particles 25 comprises or consists of a neutron absorber. The neutron absorber may also in this case comprise or consist of ZrB₂.

In the examples above, the neutron absorber comprises boron, which then may be enriched to contain a higher percentage of the isotope ¹⁰B than natural boron. For instance, the percentage may be at least 20, 30, 40, 50, 60, 70, 80 or 90% by weight of the isotope 10B.

As mentioned above, the uranium-containing material 22 may comprise of consist of at least one of UN and U₂₀Si₁₆N₃. In these examples, the nitrogen of the uranium-containing material 22 may be enriched to contain a higher percentage of the isotope ¹⁵N than natural N. For instance, the percentage may be at least 60, 70, 80 or 90% by weight of the isotope ¹⁵N.

The metallic coating 22 permits the nuclear fuel pellet 10 to be sintered in a standard sintering furnace by means of the following steps.

A powder of the uranium-containing material is provided. The powder may be formed to green particles. The green particles of the uranium-containing material are then sintered to form a plurality of the particles.

Thereafter, the metallic coating 23 is applied on the particles 21 to form a plurality of coated particles 23. The application of the metallic coating 23 may be performed by means of atomic layer deposition.

Alternatively, the application of the metallic coating 23 may be performed by means of electro-plating.

According to a still further alternative, the application of the metallic coating 23 may be performed by means of a sol-gel method, wherein a gel, in which the metal is impregnated, is applied to the particle 21. A heat treatment is then applied to burn off the gel and leave the metallic coating 23 in the particle 21.

Furthermore, a powder of uranium dioxide is provided.

The powder of uranium dioxide and the coated particles are mixed to provide a mixture. The mixture is then compressed in a suitable mold to form a green body.

Finally, the green body is sintered in the sintering furnace in a suitable atmosphere to the sintered nuclear fuel pellet 10.

The invention is not limited to the embodiments and examples described above, but may be varied and modified within the scope of the following claims.

1-15. (canceled)

16. A sintered nuclear fuel pellet, comprising a matrix of UO₂ and particles dispersed in the matrix, wherein the particles comprises a uranium-containing material, wherein each of the particles is encapsulated by a metallic coating, wherein the uranium-containing material has a uranium density that is higher than the uranium density of UO₂, characterized in that the metallic coating consists of at least one metal chosen from the group of Mo, W, Cr, V and Nb.

17. The sintered nuclear fuel pellet according to claim 16, wherein the uranium-containing material comprises at least one of uranium silicide, uranium nitride and uranium boride.

18. The sintered nuclear fuel pellet according to claim 16, wherein the uranium-containing material comprises at least one of U₃Si₂, USi, U₃Si, U₂₀Si₁₆N₃, UN and UB₂.

19. The sintered nuclear fuel pellet according to claim 16, wherein the uranium-containing material comprises and at least one of UN and U₂₀Si₁₆N₃ and wherein the nitrogen of the uranium-containing material is enriched to contain a higher percentage of the isotope ¹⁵N than natural N.

20. The sintered nuclear fuel pellet according to claim 16, wherein the particles also comprises a neutron absorber.

21. The sintered nuclear fuel pellet according to claim 16, wherein the sintered nuclear fuel pellet comprises absorbing particles comprising a neutron absorber.

22. The sintered nuclear fuel pellet according to claim 20, wherein the neutron absorber comprises ZrB₂.

23. The sintered nuclear fuel pellet according to claim 20, wherein the uranium-containing material comprises UBₓ, especially UB₂, and wherein the boron of said UBₓ forms the neutron absorber.

24. The sintered nuclear fuel pellet according to claim 22, wherein the boron is enriched to contain a higher percentage of the isotope ¹⁰B than natural boron.

25. The sintered nuclear fuel pellet according to claim 16, wherein the particles have an extension that lies in the range from 100 microns to 2000 microns.

26. A fuel rod comprising a cladding tube enclosing a plurality of sintered nuclear fuel pellets according to claim 16.

27. A fuel assembly for use in a nuclear reactor, comprising a plurality of fuel rods according to claim 26.

28. A method of manufacturing a sintered nuclear fuel pellet according to claim 16, the method comprising the steps of: providing a powder of an uranium-containing material, sintering the uranium-containing material to form a plurality of particles, applying a metallic coating on the particles to form a plurality of coated particles, providing a powder of uranium dioxide, mixing the powder of uranium dioxide and the coated particles to provide a mixture, compressing the mixture to form a green body, sintering the green body to the sintered nuclear fuel pellet.

29. The method of claim 28, wherein the application step comprises applying the metallic coating on the particles by atomic layer deposition.

30. The method of claim 29, wherein the application step comprises applying the metallic coating on the particles by electro-plating.
